(19) United States
(12) Patent Application Publication
(10) Pub. No.: US 2026/0077491 A1
(43) Pub. Date: Mar. 19, 2026

(54) Item Modelling Unit for an Industrial Robot for Manipulating Items

(71) Applicant: ABB Schweiz AG, Baden (CH)

(72) Inventors: Tom Blondeel, Halle (BE); Jordi Artigas, Barcelona (ES)

(73) Assignee: ABB Schweiz AG, Baden (CH)

(21) Appl. No.: 19/398,186

(22) Filed: Nov. 24, 2025

Related U.S. Application Data
(63) Continuation of application No. PCT/EP2023/064520, filed on May 31, 2023.

(51) Int. Cl. B25J 9/16; B25J 19/02

(52) U.S. Cl. CPC B25J 9/163; B25J 9/1669; B25J 19/021

(57) ABSTRACT

An item modelling unit for an industrial robot for manipulating an item includes at least one sensor and a processing unit. The at least one sensor is disposed on a horizontal moving component of the industrial robot. The horizontal moving component moves in a horizontal direction during manipulation of the item. The at least one sensor obtains property data of the item during manipulation of the item. The processing unit determines a model of the item during manipulation of the item using the property data of the item.

### CROSS-REFERENCE TO RELATED APPLICATIONS

The instant application claims priority to International Patent Application No. PCT/EP2023/064520, filed May 31, 2023, which is incorporated herein in its entirety by reference.

### FIELD OF THE DISCLOSURE

The present disclosure generally relates to an item modelling unit for an industrial robot for manipulating items, a method for modelling an item using an item modelling unit for an industrial robot, and an industrial robot comprising the item modelling unit.

### BACKGROUND OF THE INVENTION

In logistics or e-commerce applications industrial robots are often used to move items, for example different goods or articles. While handling the items, information of the item is usually extracted to get a good idea of what is treated by the industrial robot and why. The state of the art for gathering item properties is typically based on either using external sensors (i.e. not mounted on the industrial robot) or embarking the sensor on the robot end effector. However, both approaches have limited functionality. If for instance a 3D model of the picked item is to be extracted, an external sensor will require the industrial robot to stop translational movements in front of the sensor ﬁeld of view and perform some rotational movements in order to allow the sensor to capture the object from the different angles.

Such an approach however is inconsistent and as such complex to control. Furthermore, cycle times of the movement of the industrial robot are consequently either relatively long or in consistent. In addition, depending on the workspace of the industrial robot and the task or application that is carried out by the industrial robot determination of the model relatively often fails because the sensors are not able to extract enough data from the item.

Consequently, there is the need for a more consistent and reliably item modelling unit for an industrial robot for manipulating items that is able to provide a model of the manipulated item.

### BRIEF SUMMARY OF THE INVENTION

In one aspect, the present disclosure describes an item modelling unit for an industrial robot for manipulating an item, which comprises at least one sensor and a processing unit. The at least one sensor is configured to be disposed on a horizontal moving component of the industrial robot, wherein the horizontal moving component is configured to move in a horizontal direction, only a horizontal direction, during manipulation of the item. The at least one sensor is configured to obtain property data of the item during manipulation of the item. The processing unit is configured to determine a model of the item during manipulation of the item, using the property data of the item.

In other words, the item modelling unit, or at least the at least one sensor of the item modelling unit, is placed on the industrial robot and moves along with a rotating movement of the industrial robot. Thus, the modelling unit determines a model, such as a digital model, of the item, or object, during manipulation of the item by the industrial robot. Thus, the item can be processed during manipulation, reducing waiting time in a manipulation process of subsequent items that would be needed for processing the item, in particular, determining a model of the item. For example, an external sensor will require the industrial robot to stop translational, for example horizontal, movements in front of the sensor field of view and perform some rotational movements in order to allow the at least one sensor to capture the item from the different angles. The item modelling unit according to the aspect of the invention allows to do the same without stopping the industrial robot.

### BRIEF DESCRIPTION OF THE SEVERAL VIEWS OF THE DRAWINGS

FIG. 1 is a schematic view of an industrial robot for manipulating items with an integrated item modelling unit in accordance with a first embodiment of the present disclosure.

FIG. 2 is a perspective view of an industrial robot for manipulating items with integrated item modelling unit in accordance with a second embodiment of the present disclosure.

### DETAILED DESCRIPTION OF THE INVENTION

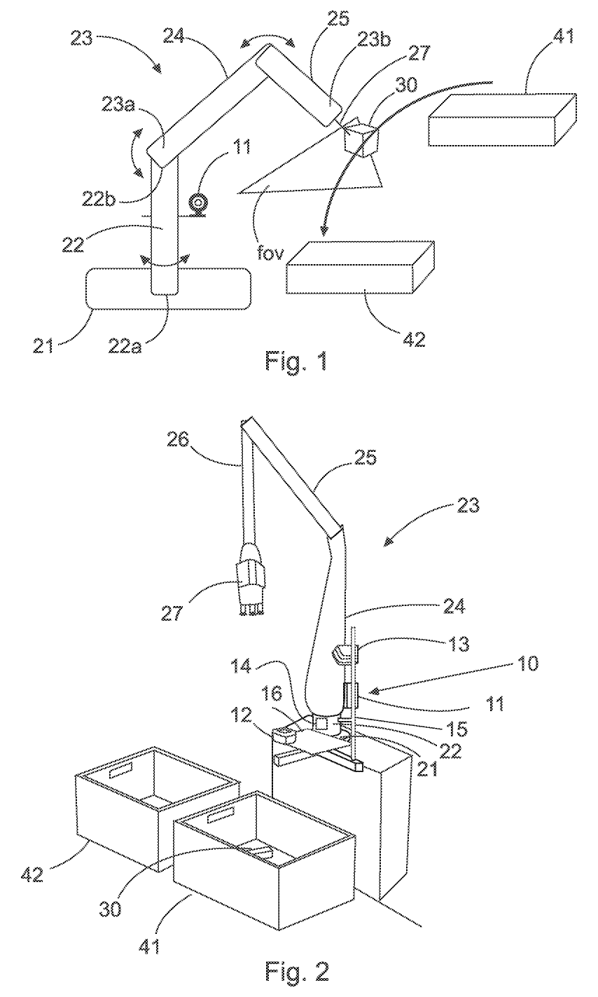

FIG. 1 shows the industrial robot 20 in accordance with a first embodiment. The industrial robot 20 comprises a base 21, supporting a first arm component 22. The first arm component 22 is connected to the base 21, wherein the first arm component 22 extends vertically from the base 21 upwards. The first arm component 22 is able to rotate horizontally on the base 21, in particular only able to rotate horizontally on the base 21. The horizontal movement of the first arm component 22 allows a movement of 360°. The first arm component 22 comprises a first end 22a, with which the first arm component 22 is connected to the base 21, for example via a first joint. The first arm component 22 comprises a second end 22b, opposite of the first end 22a. The second end 22b is connected to a second arm component 23, for example via a second joint. In particular, the second arm component 23 comprises a third end 23a, which is connected to the second end 23b of the first arm component 22. The second arm component 23 is connected with the first arm component 22 to be able rotate vertically around the second end 22b of the first arm component 22. The second arm component 23 further comprises a first vertical arm 24 and a second vertical arm 25, wherein the second vertical arm 25 is connected to the first vertical arm 24 to be able to rotate vertically around the first vertical arm 24, in particular via a third joint. The second arm component 23 further comprises a fourth end 23b, which is connected to a manipulator unit 27, for example via a fourth joint. The manipulator unit 27 is configured to manipulate an item 30. In this case, the manipulator unit 27 is a gripper, which is configured to grip the item 30 and together with the movements of the first arm component 22 and the second arm component 23, the industrial robot 20 is able to pick up the item 30 from a first spot 41, in this case a first box, move the item 30 to a second spot 42, in this case a second box, and put the item 30 down into the second box.

On the industrial robot 20 an item modelling unit 10 is disposed that is configured to determine a model of the item 30. In order to determine the model of the item 30, the item modelling unit 10 needs property data of the item 30, which can be captured by at least one sensor, comprising a first sensor 11 of the item modelling unit 10. The first sensor 11 is disposed on a horizontal moving component of the industrial robot 20, wherein the horizontal moving component is configured to move in a horizontal direction during manipulation of the item 30. In this case, the horizontal moving component is the first arm component 22 and as such the first sensor 11 horizontally moves with any horizontal movement of the first arm component 22. The first sensor 11 thus always has the item 30 in its field of view fov while manipulating the item 30.

An item modelling unit 10 capable of capturing the item 30 that is picked up and moved by the industrial robot 120 during the movement from the first spot 41 to the second spot 42 without the need to stop, without the danger of collision between the industrial robot 20 and the first sensor 11, is provided. Thus, an industrial robot 20 for manipulating items 30 with integrated item modelling unit 10 for reliable and consistent logistics application can be provided.

FIG. 2 shows the industrial robot 120 in accordance with a second embodiment. Compared to the first embodiment, the industrial robot 120 comprises an additional third vertical arm 26 as part of the second arm component 23. Furthermore, the item modelling unit 10 comprises a storage shelf 16, which is connected to the first arm component 22 by a support structure 15, so that the storage shelf 16 moves horizontally in accordance with horizontal movement of the first arm component 22. Furthermore, the at least one sensor comprises a first sensor 11, a second sensor 12 and a third sensor 13, which are all rigidly fixed to the support structure 15, wherein for example the support structure comprise metal rods. In other words, the support structure 15 supports the first sensor 11, the second sensor 12, the third sensor 13 and the storage shelf 16 at the first arm component 22 of the industrial robot 120. In particular, the first sensor 11 is located horizontally above the storage shelf 16 and is align in a sideway direction, being able to capture the item 30 being held by the manipulator unit 27 or being disposed on the storage shelf 16 from the side. The second sensor 12 is located in a horizontal plane of the storage shelf 16 and is aligned in an upward direction, being able to capture a bottom of the item 30, when the item 30 is picked up or set down by the manipulator unit 27. The third sensor 13 is located horizontally above the storage shelf 16 and horizontally above the first sensor 11 and is aligned in a downward direction, being able to capture a top of the item 30, when the item 30 is picked up or set down by the manipulator unit 27 or when the item 30 is disposed on the storage shelf 27. In other words, a field of view of the first sensor 11 is aligned lateral, a field of view of the second sensor 12 is aligned upwards and a field of view of the third sensor 13 is aligned downwards.

The industrial robot 120 is configured to move the item 30 from the first spot 41 to the second spot 42. Between this movement, the industrial robot 120 is configured to shortly store the item 30 on the storage shelf 16, or in other words, to put down the item 30 on the storage shelf 16. The manipulator unit 27 thereby can be configured to let go of the item 30 and regrip it afterwards or just maintain its grip on the item 30 during intermediate storage. Furthermore, the industrial robot 120 can be configured to rotate to item 30 on the storage shelf 27 horizontally or vertically.

The industrial robot of the second embodiment allows to execute a logistics or e-commerce application of moving the item 30 from the first spot 41 to the second spot 42 with an intermediate storage, or intermediate stop, on the storage shelf 16 and thereby capture enough property data of the item 30 to allow the item modelling unit 10 to determine a model of the item 30 during the logistics application. The item modelling unit 10 thus comprises a processing unit 14, which is configured to determine the model of the item 30. The processing unit 14 is connected to the at least one sensor 11, 12, 13 and is configured to determine the model of the item 30 based on the property data of the item, obtained by the at least one sensor 11, 12, 13. The processing unit 14 can be disposed on the industrial robot 120, but maybe also disposed apart from the industrial robot 120.

This allows to provide an item modelling unit 10, which is capable of capturing the item 30 that is picked up and moved by the industrial robot 120 during the movement from the first spot 41 to the second spot 42 without the need to stop and without the danger of collision between the industrial robot 120 and the first sensor 11, the second sensor 12, the third sensor 13 or the storage shelf 16. Thus, an industrial robot 120 for manipulating items with integrated item modelling unit 10 for reliable and consistent logistics application can be provided.

The term “item”, as used herein, comprises an object that should be manipulated by the industrial robot, for example a parcel, preferably comprising a packet.

The term “model”, as used herein, comprises a digital representation of the item. The model for example comprises a representation of the item, wherein at least one of the property data is associated to the item. Thus, the processing unit is preferably configured to associate at least one of the property data to the respective item.

For example, the property data is used to detect if the industrial robot handles dangerous goods or not, to adapt the application of the industrial robot accordingly.

Because the at least one sensor is disposed on the industrial robot, on the horizontal moving component, the at least one sensor moves together with movements of the industrial robot, thereby avoiding collisions between the at least one sensor and the industrial robot. Furthermore, the scanning speed is drastically accelerated.

Because the at least one sensor is disposed on the industrial robot, specifically, on the horizontal moving component, the item modelling unit works independent or in other words decoupled of a layout and application of the industrial robot and/or the workspace of the industrial robot.

Preferably, the at least one sensor is configured to obtain the property data of the item while the manipulator unit manipulates the item. In other words, the actual task of the industrial robot, i.e., moving the item from a first spot to a second spot, is not interrupted by scanning process, i.e. the obtaining the property data of the item by the at least one sensor.

Preferably, manipulating the item comprises flipping, by the manipulator unit, so that the at least one sensor can obtain sufficient property data of the item. Thus, the property data of the item are obtained in real time and on-the-fly during manipulation of the item, and a consistent and reliable item modelling unit that determines a model of the manipulated item is provided.

In a preferred embodiment, manipulating the item comprises moving the item from a first spot to a second spot. For example, the first spot comprises a bin or a pallet and the second spot comprises another bin or a conveyor belt. Thus, the manipulation of the item comprises picking up the item in the first spot, moving the item to the second spot, in particular in a horizontal trajectory, and putting down the item in the second spot.

For example, manipulating the item comprises at least one of bin picking, order picking, depalletizing, parcel singulation, induction into sorters and machine tending. This allows determining a model within a predetermined application cycle of manipulating the item.

Because the at least one sensor is disposed on the industrial robot and the at least one sensor moves together with movements of the industrial robot the item modelling unit is able to determine a model of the item without stopping the robot. In common approach, for example with an external sensor, in order to determine a model of the item, the robot needs to stop translational movements in front of the field of view of the sensor and perform rotational movements of the item in order to allow the sensor to capture the item from different angles. Thus, a consistent and reliable item modelling unit that is able to determine a model of the manipulated item is provided.

In a preferred embodiment, manipulating the item comprises performing at least one motion pattern of the item during moving the item from the first spot to the second spot.

The at least one motion pattern allows the at least one sensor to scan the manipulated item, or in other words to obtain the property data, from a plurality of angles while moving the item from the first spot to the second spot.

In a preferred embodiment, the first spot is horizontally offset from the second spot.

In a preferred embodiment, the at least one sensor comprises a plurality of sensors, being aligned in different directions.

In a preferred embodiment, the at least one sensor comprises a first sensor, a second sensor and a third sensor, wherein the first sensor is aligned in sideway direction, wherein the second sensor is aligned in an upwards direction and wherein the third sensor is aligned in a downward direction.

In a preferred embodiment, the at least one sensor comprises a vision sensor.

Preferably, the vision sensor comprises a camera, a scanner, and or a bar code reader.

In a preferred embodiment, the property data comprises a three-dimensional model of the item, a weight of the item, a color of the item, a density of the item, a barcode/QR-code information of the item and/or an item type of the item.

The item type preferably comprises a packaging type of the item, for example polybag, cardboard, glass.

In a preferred embodiment, the item modelling unit comprises a support structure, supporting the at least one sensor on the horizontal moving component and a storage shelf, wherein the storage shelf is supported by the support structure.

Preferably, the manipulator unit flips the item on the storage shelf, so that the at least one sensor can obtain a sufficient amount of property data of the item.

In other words, instead of flipping the item during the movement from the first spot to the second spot in the air, the manipulator unit can make use of the storage shelf to flip the item.

Preferably, the at least one sensor comprises a plurality of sensors, for example three sensors, that are fixed to the storage shelf in different angles to the storage shelf so that the plurality of sensors can obtain the property data of the item without flipping the item on the storage shelf.

In other words, the plurality of sensors fixed to the storage shelfs allows obtaining sufficient property data of the item by only placing the item on the storage shelf for a predetermined, relatively short, amount of time.

As the storage shelf is fixed to the horizontal moving component, the at least one sensor fixed to the storage shelf also moved along the horizontal movement of the horizontal moving component without getting into the way of the industrial robot when turning horizontally and without losing the item out of sight.

According to an aspect of the invention, a method for modelling an item using an item modelling unit for an industrial robot, as described herein, comprises the following steps: Manipulating, by the manipulator unit, the item. Obtaining, by the item modelling unit, property data of the item during manipulation of the item. Determining, by the item modelling unit, a model of the item during manipulation of the item.

In a preferred embodiment, manipulating the item comprises moving the item from a first spot to a second spot.

In a preferred embodiment, manipulating the item comprises performing at least one motion pattern of the item during moving the item from the first spot to the second spot.

In a preferred embodiment, the first spot is horizontally offset from the second spot.

In one aspect, the disclosure describes an industrial robot that comprises a base, a first arm component, comprising a first end and a second end, a second arm component, comprising a third end and a fourth end and an item modelling unit, as described herein. The first end of the first arm component is supported horizontally rotatable around a first axis on the base. The third end of the second arm component is supported rotatable around a second axis on the second end of the first arm component. The second arm component comprises a manipulator unit disposed at the fourth end of the second arm component, wherein the manipulator unit is configured to manipulate the item. The at least one sensor of the item modelling unit is disposed on the first arm component.

In other words, the item modelling unit, or at least the at least one sensor of the item modelling unit, is placed on the industrial robot and moves along with a rotating movement of the first arm component around the base.

The term “manipulator unit”, as used herein, describes the last element in the kinematic chain of the industrial robot. In other words, as the industrial robot in this case is used in a logistics application or e-commerce application, an end effector of the industrial robot is the manipulator unit. The manipulator unit preferably comprises a gripping tool for example using suction cups.

The term “industrial robot”, as used herein, describes an automatic robot arm that as it is usually used in manufacturing applications. The industrial robot comprises a plurality of arm components that are connected with each other via joints in order to achieve a plurality of degrees of freedom for moving an end effector of the industrial robot. For example, the industrial robot has six axes.

Preferably, the industrial robot is an industrial logistics robot arm.

Preferably, the first arm component extends vertically from the base, wherein the first end of the first arm component is a lower end of the first arm component, and the second end of the first arm component is an upper end of the first arm component.

For example, the property data is used to detect if the industrial robot handles dangerous goods or not, in order to adapt the application of the industrial robot accordingly.

Because the at least one sensor is disposed on the first arm component, the at least one sensor moves together with movements of the industrial robot, thereby avoiding collisions between the at least one sensor and the industrial robot. Furthermore, the scanning speed is drastically accelerated.

Because the at least one sensor is disposed on the first arm component, the item modelling unit works independent or in other words decoupled of a layout and application of the industrial robot and/or the workspace of the industrial robot.

Consequently, the industrial robot that is generally used in manufacturing can be efficiently used in logistics applications.

Thus, a consistent and reliable industrial robot for manipulating items that is able to process the manipulated item is provided.

Preferably, the second arm component is supported vertically rotatable around the second axis on the second end of the first arm component.

In other words, the first arm component provides the general horizontal movement of the industrial robot and as such the manipulator unit. The second arm component provides the other degrees of freedom of movement, including to some extend horizontal movement, of the industrial robot.

In a preferred embodiment, the second arm component comprises a plurality of arms movably joined together with joints.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### List of references

10 item modelling unit

11 first sensor

12 second sensor

13 third sensor

14 processing unit

15 support structure

16 storage shelf

20 industrial robot

21 base

22 first arm component

22a first end

22b second end

23 second arm component

23a third end

23b fourth end

24 first vertical arm

25 second vertical arm

26 third vertical arm

27 manipulator unit

30 item

41 first spot

42 second spot

120 industrial robot

fov field of view

What is claimed is:

1. An item modelling unit for an industrial robot for manipulating an item, comprising:
at least one sensor; and
a processing unit;
wherein the at least one sensor is disposed on a horizontal moving component of the industrial robot;
wherein the horizontal moving component is configured to move in a horizontal direction during manipulation of the item;
wherein the at least one sensor is configured to obtain property data of the item during manipulation of the item; and
wherein the processing unit is configured to determine a model of the item during manipulation of the item using the property data of the item.

2. The item modelling unit of claim 1, wherein manipulating the item comprises moving the item from a first spot to a second spot.

3. The item modelling unit of claim 2, wherein manipulating the item comprises performing at least one motion pattern of the item during motion of the item from the first spot to the second spot.

4. The item modelling unit of claim 2, wherein the first spot is horizontally offset from the second spot.

5. The item modelling unit of claim 1, wherein the at least one sensor comprises a plurality of sensors being aligned in different directions.

6. The item modelling unit of claim 5, wherein the at least one sensor comprises a first sensor, a second sensor, and a third sensor; wherein the first sensor is aligned in a sideway direction, wherein the second sensor is aligned in an upward direction, and wherein the third sensor is aligned in a downward direction.

7. The item modelling unit of claim 1, wherein the at least one sensor comprises a vision sensor.

8. The item modelling unit of claim 1, wherein the property data comprises a three-dimensional model of the item, a weight of the item, a color of the item, a density of the item, a barcode/QR-code information of the item and/or an item type of the item.

9. The item modelling unit of claim 1, further comprising:
a support structure supporting the at least one sensor on the horizontal moving component; and
a storage shelf;
wherein the storage shelf is supported by the support structure.

10. A method for modelling an item using an item modelling unit for an industrial robot, the item modelling unit comprising at least one sensor and a processing unit; the at least one sensor being disposed on a horizontal moving component of the industrial robot; the horizontal moving component being moveable in a horizontal direction during manipulation of the item; the at least one sensor being configured to obtain property data of the item during manipulation of the item; and the processing unit being configured to determine a model of the item during manipulation of the item using the property data of the item; the method comprising:
manipulating, by the manipulator unit, the item;
obtaining, by the item modelling unit, property data of the item during manipulation of the item; and
determining, by the item modelling unit, a model of the item during manipulation of the item.

11. The method of claim 10, wherein manipulating the item comprises moving the item from a first spot to a second spot.

12. The method of claim 11, wherein manipulating the item comprises performing at least one motion pattern of the item while moving the item from the first spot to the second spot.

13. The method of claim 11, wherein the first spot is horizontally offset from the second spot.

14. An industrial robot, comprising:
a base;
a first arm component comprising a first end and a second end;
a second arm component comprising a third end and a fourth end; and
an item modelling unit comprising at least one sensor, and a processing unit;
wherein the first end of the first arm component is supported horizontally rotatable around a first axis on the base;
wherein the third end of the second arm component is supported rotatable around a second axis on the second end of the first arm component;
wherein the second arm component comprises a manipulator unit disposed at the fourth end of the second arm component;
wherein the manipulator unit is configured to manipulate the item; and
wherein the at least one sensor of the item modelling unit is disposed on the first arm component.

15. The industrial robot of claim 14, wherein the second arm component comprises a plurality of arms movably joined together with joints.
